(19) United States
(12) Patent Application Publication
(10) Pub. No.: US 2013/0204634 A1
(43) Pub. Date: Aug. 8, 2013

(54) MLR and CPT Cost Determination System

(71) Applicant: Dasarath Tilak Bandara KIRIDENA, Washington, DC (US)

(72) Inventor: Dasarath Tilak Bandara KIRIDENA, Washington, DC (US)

(21) Appl. No.: 13/752,266

(22) Filed: Jan. 28, 2013

Related U.S. Application Data
(60) Provisional application No. 61/591,092, filed on Jan. 26, 2012.
(60) Provisional application No. 61/591,691, filed on Jan. 27, 2012.

(51) Int. Cl. G06Q 50/22

(52) U.S. Cl. CPC G06Q 50/22; G06Q 30/0283
USPC 705/2

(57) ABSTRACT

A method and computer program product are provided for determining healthcare service cost. For example, the method can include determining one or more procedures associated with the healthcare service. Personnel can be determined for each of the one or more procedures. For each personnel associated with each of the one or more procedures, a personnel cost can be determined based on a recorded actual time incurred in a predetermined period. Further, the method can include determining the healthcare service cost based on the personnel costs associated with the personal for each of the one or more procedures.

### CROSS REFERENCE TO RELATED APPLICATIONS

This application claims the benefit of U.S. Provisional Application No. 61/591,092 (SKGF Ref. No. 2879.0010000), filed Jan. 26, 2012, titled “Real-Time MLR and CPT Cost Determination System,” and U.S. Provisional Application No. 61/591,691 (SKGF Ref. No. 2879.0010001), filed Jan. 27, 2012, titled “Real-Time MLR and CPT Cost Determination System,” which are both incorporated herein by reference in their entireties.

### BACKGROUND

1. Field

Embodiments generally relate to a moving labor rate (MLR) and current procedural terminology (CPT) cost determination system.

2. Background

The United States healthcare industry has an urgent need to consolidate healthcare delivery with financial data to create accountability, monitoring, transparency, and performance that the American public demands from the healthcare industry.

The Health Information Technology for Economic and Clinical Health (HITECH) Act provides a historic opportunity for re-aligning the healthcare industry to better serve the aging American population, while bringing measurability and accountability that will be required to plan for future expanded health services that the country has to prepare to deliver.

Per empirical evidence, the current medical reimbursement process relies extensively on retrospective administrative tracking systems to identify and determine the cost of health delivery. Further, payments to providers are made on antiquated rates and, in a majority of the cases, the costs are remotely tied to the actual cost of each service. This situation has been compounded by the lack of a process to determine the true cost of a healthcare claim. Its outcome has been the use of interim payments for provider compensation.

In the healthcare cost landscape, most health providers operate blindly to the actual cost of healthcare. The true costs of running a healthcare facility (e.g., hospital) are known many years later; annual financial statements are prepared only after the end of fiscal years; and, audits of the health costs are performed between 1 and 3 years. Therefore, the healthcare facility is not able to identify the true costs of its operations until a couple of years after the fiscal years ends. This issue is compounded by the fact that Medicare and Medicaid audits (typically performed by the Federal and State governments) are done 2-3 years after the end of a fiscal year.

### SUMMARY

By developing a cost-management system that can track expenses for each medical/healthcare procedure, it will help healthcare facilities (e.g., hospital) to quickly implement strategies to manage costs during the fiscal year; enable continuous ability to track costs and identify excess or wasteful spending and quickly take remedial action to redirect resources to areas that them the most. For instance, for a hospital with identical staffing ratios for two departments (e.g., emergency and OBGYN departments), if emergency care services department provides 100 services compared to OBGYN's 5 services (against an estimated 25 services), then resources can be re-directed or adjusted to provide support to the emergency department.

Therefore, what is needed is a method and system for computing health care costs and timelines to support current and future healthcare payment mechanisms. This method and system can rely on predetermined rates to reimburse healthcare service costs. In turn, a real-time cost for healthcare procedures can be realized.

An embodiment includes a method for determining healthcare service cost. The method can include the following: determining one or more procedures associated with the healthcare service; determining personnel for each of the one or more procedures; determining, for each personnel associated with each of the one or more procedures and with a computing device, a personnel cost based on a recorded actual time incurred in a predetermined period; and, determining, with the computing device, the healthcare service cost based on the personnel costs associated with the personal for each of the one or more procedures.

The predetermined time can be dynamically determined based on a current time, include a moving window of a predetermined time period, and/or include a year-to-date time period or a pay-period-to-date time period. The recorded actual time can be determined based on payroll data from one or more payroll periods. The recorded actual time can be determined based on payroll data from one or more payroll periods. Further, the personnel cost is determined based on a total amount earned and total hours worked by the personnel.

Another embodiment includes a method for comparing healthcare service cost across a plurality of healthcare providers. The method can include the following: determining, for each healthcare provider and with a computing device, a personnel cost for a healthcare service, wherein the personnel cost is determined based on a recorded actual time incurred in a predetermined period; comparing, with the computing device, the personnel cost for each of the plurality of healthcare providers; and, selecting, with the computing device, a healthcare provider from the plurality of healthcare providers based on the personnel cost associated with each of the plurality of healthcare providers.

The healthcare service can be associated with a uniform current procedural terminology (CPT) code and/or include personnel and healthcare procedures customized to an individual patient. Further, when determining the personnel cost, this step can include incorporating a medical supply cost associated with the healthcare service, incorporating an overhead cost associated with the healthcare service, and/or incorporating an employee benefit cost.

A further embodiment includes a computer program product comprising a non transitory machine-usable medium having computer program logic recorded thereon enabling a processor to analyze software code. The computer program logic can include the following: first computer readable program code that enables a processor to receive input data, wherein the input data comprises payroll data, material and supply inventory, and current procedural terminology (CPT) codes; second computer readable program code that enables a processor to process the input data to determine a real-time cost of a healthcare service; and, third computer readable program code that enables a processor to report healthcare service information based on the real-time cost of the healthcare service.

The second computer readable program code can include fourth computer readable program code that enables a processor to receive data from at least one of a payroll database system, a human resources database system, an inventory system, or a combination thereof. Further, the third computer readable program code can include fourth computer readable program code that enables a processor to provide a customized interface to a healthcare provider administrator, a chief financial officer, or both.

Further features and advantages of the embodiments disclosed herein, as well as the structure and operation of the embodiments, are described in detail below with reference to the accompanying drawings. It is noted that the invention is not limited to the specific embodiments described herein. Such embodiments are presented herein for illustrative purposes only. Additional embodiments will be apparent to person skilled in the relevant art based on the teachings contained herein.

### BRIEF DESCRIPTION OF THE DRAWINGS

The accompanying drawings, which are incorporated herein and form a part of the specification, illustrate embodiments and, together with the description, further serve to explain the principles of the invention and to enable a person skilled in the relevant art to make and use the invention.

FIG. 1 is an illustration of an embodiment of a moving labor rate (MLR) workflow diagram.

FIG. 2 is an illustration of an embodiment of a moving labor rate (MLR) calculation algorithm.

FIG. 3 is an illustration of an example real-time procedure rate.

FIG. 4 is an illustration of an embodiment of a real-time inventory cost (RTIC) calculation algorithm.

FIG. 5 is an illustration of an embodiment of a workflow for calculating real-time procedure cost.

FIG. 6 is an illustration of an embodiment of a flowchart depicting the determination of a real-time cost of a healthcare service.

FIG. 7 is an illustration of an embodiment of a flowchart depicting the determination of a moving labor rate (MLR) for healthcare service cost determination.

FIG. 8 is an illustration of an embodiment of a system for healthcare service cost determination.

FIG. 9 is an illustration of an embodiment of database for a real-time healthcare service cost determination system.

FIG. 10 is an illustration of an example computer system in which embodiments, or portions thereof, can be implemented as computer readable code.

Embodiments will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the scope of the invention. Rather, the scope of the invention is defined by the appended claims.

It would be apparent to a person skilled in the relevant art that the embodiments, as described below, can be implemented in many different forms of software, hardware, firmware, and/or the entities illustrated in the figures. Thus, the operational behavior of the embodiments disclosed herein will be described with the understanding that modifications and variations of the embodiments are possible, given the level of detail presented herein.

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of a person skilled in the relevant art to effect such feature, structure, or characteristic in connection with other embodiments whether or not explicitly described.

### 1. Introduction

Healthcare service providers all over the country have no standard way of identifying its actual costs in a timely manner. Embodiments provide a standardized index to identify real-time costs by developing rates for each classification of healthcare services provided. Embodiments incorporate concepts such as Moving Labor Rate (MLR) and Moving Current Procedural Terminology Code Cost (CPTCC), which are both discussed in detail below.

For explanation purposes, embodiments are described in the context of the healthcare industry. Based on the description, a person of ordinary skill in the art will recognize that the embodiments are applicable to other industries.

### 2. Moving Labor Rate (MLR)

An embodiment is the establishment of a moving labor rate (MLR) for each employee (e.g., healthcare procedure provider personnel) by its calculation based on an actual amount of services provided. For example, it can be assumed that an employee provides 40 hours of labor per week, but this may not be the actual service time provided for a specific service. MLR can be used to calculate the real-time cost based on the actual service time (e.g., hours and minutes) performed by an employee towards a particular medical, surgical, clinical, or administrative procedure, according to an embodiment. In an embodiment, after each payroll period (or other predetermined period), the changed Labor Rate can be calculated which takes into account the new time and cost rendered by the healthcare service provider. Accordingly, new data to be appended to the existing database for each pay period by being routinely submitted to the engine for processing and computation. In an embodiment, the computed MLR is an hourly rate.

In order to keep track of the specific time spent on a service, the present transformation can be utilized into electronic documentation in which every employer could record their time for each procedure immediately, according to an embodiment. Thus, calculations could take into account each set of data per procedures in computing an MLR for a pre-determined period of time.

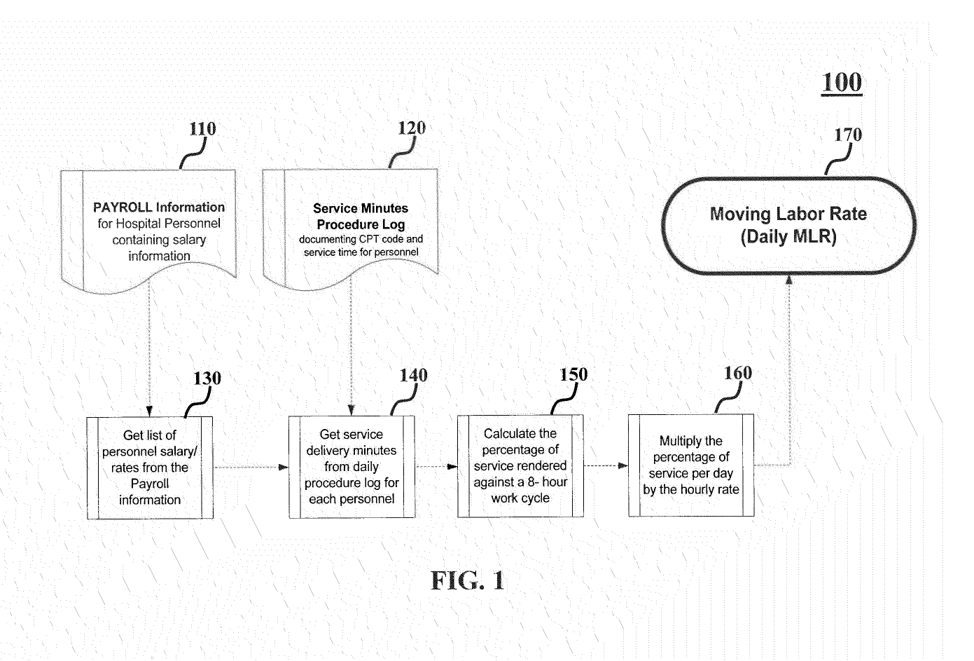

FIG. 1 is an illustration of an embodiment of an MLR workflow diagram 100. In an embodiment, employee payroll data 110 can include employee identification (ID), name, Social Security Number (SSN), and other employee information such as address, marital status, number of exemptions, hourly rate or salary per day/pay period, amount of deductions per day/pay period, birth date and hire date and termination date.

For explanation purposes, a hypothetical health care provider and three physicians employed therein are assumed. The fixed labor cost rate of each physician has been budgeted at $250.00. In an embodiment, the MLR factors in what each physician provides in terms of actual recorded time for their service rendered. Services rendered includes, for example and without limitation, clinical, medical, or administrative service time spent by the physician related to the respective procedure. Thus, according to the hypothetical tabulation given herein, the following three scenarios can take place.
Scenario 1: Physician #1 has no change in real time costs for the 40 hours of service rendered. Accordingly, his MLR is identical to the budgeted rate.
Scenario 2: Although physician #2 has rendered 30 hours of service, the hospital will nonetheless have to pay him $10,000 for the week at the budgeted rate of $250.00 per hour for a 40-hour week. The outcome will be that the cost to the provider (e.g., healthcare provider) will be a MLR of $291.67 per hour or 33% higher than the hourly budgeted rate for Physician #2. The latter implies that the provider will need to increase the labor cost by 33% when calculating the medical procedure cost for Physician #2, for that particular procedure.
Scenario 3: Similarly, in the case of Physician #3, who has spent 50 hours per week with patients, the labor cost to the hospital for that specific procedure shall reduce by 40%. Hence the cost to the hospital is a MLR of $200.00 per hour or a rate reduction of 40% of the budgeted cost for Physician #3 to conduct that procedure. The latter implies that the real-time costs for the provider will need to reduce the labor cost for the Physician by 40% when calculating the cost of that specific medical procedure conducted by Physician #3.

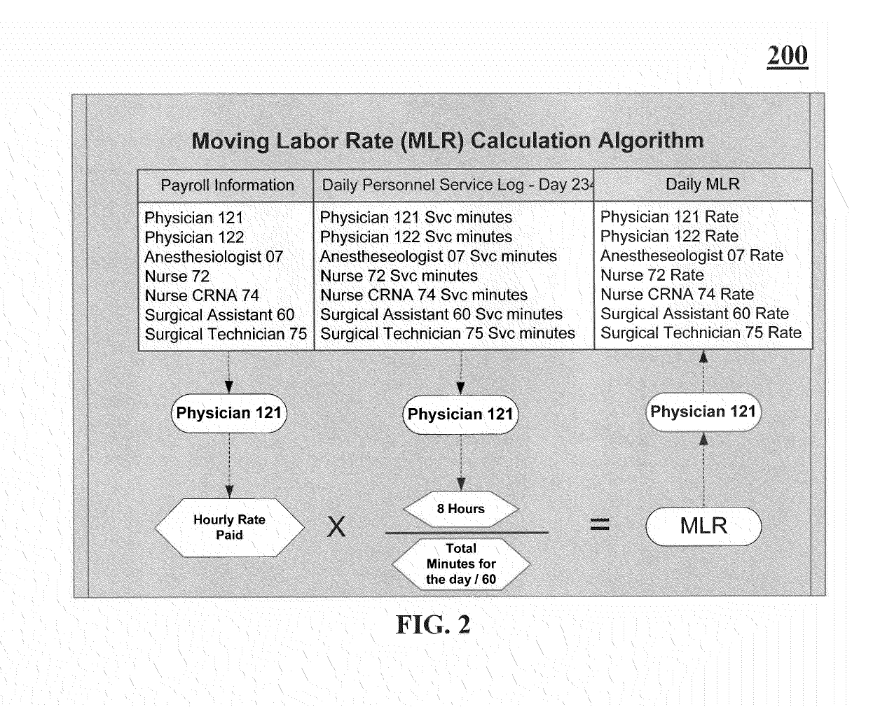

The aforementioned calculation of the MLR applies to all medical, clinical and administrative staff involved in a specific procedure*. Table 1 below summarizes the above three scenarios in tabular format. FIG. 2 is an illustration of an embodiment of an MLR calculation algorithm 200.

TABLE 1
Summary of Hypothetical Scenarios for Three Physicians

| | | | | Actual | Labor | | | |
|---|---|---|---|---|---|---|---|---|
| | | Weekly | Fixed | Hourly | Rate: | | | |
| Physician | Physician | Patient | Weekly | Cost | Increase/ | Cost | | |
| Number | Rate | Hours* | Cost | (MLR) | Decrease | Up/Down | | MLR |
| Physician 1 | $250 | 40 | $10,000 | $250.00 | N/A | No | $250.00 | — |
| | | | | | | Change | | |
| Physician 2 | $250 | 30 | $10,000 | $333.33 | 33% | Up | $291.67 | Increase |
| Physician 3 | $250 | 50 | $10,000 | $200.00 | 20% | Down | $177.78 | Decrease |

a. Moving Labor Rate Classification and its Use for Area-Wide Contrast

In an embodiment, by establishing an MLR for each classification of healthcare service provider (e.g., OBGYN, psychiatrist, dermatologist, etc.), its county, regional, state and national average can be set for comparison and analysis for contrasts, based on the rate indices in each District, County or Region, Consequently, once the database is established, it will provide a unique way for healthcare providers across the country to develop MLR's in a systematic and scientific manner. The MLR's can impact a significant transformation for healthcare providers to identify their actual cost on a real-time basis. The latter will be key for computing the real time rate for each specific Current Procedural Terminology (CPT) procedure, which will be described in detail below.

b. Basis for Computation of Real-Time Moving CPT Rate—Procedure Rate (RTPR)

The Healthcare service providers all over the country lack a standard method of identifying the actual cost of a CPT code that it utilizes to bill health insurance providers. CPT codes are numbers assigned to every task and service that may be provided by a medical practitioner to a patient, including medical, surgical, clinical, and diagnostic services. Hospitals, for example, use CPT codes to bill for services rendered to patients.

CPT Codes are used by healthcare providers/practitioners to bill claims to health insurance systems for payment. Public and private health insurers use the CPT code to compute the amount of reimbursement that a provider/practitioner will receive from the insurer. The CPT codes can be uniformly used across an industry (e.g., healthcare industry) to ensure consistency across geographical regions.

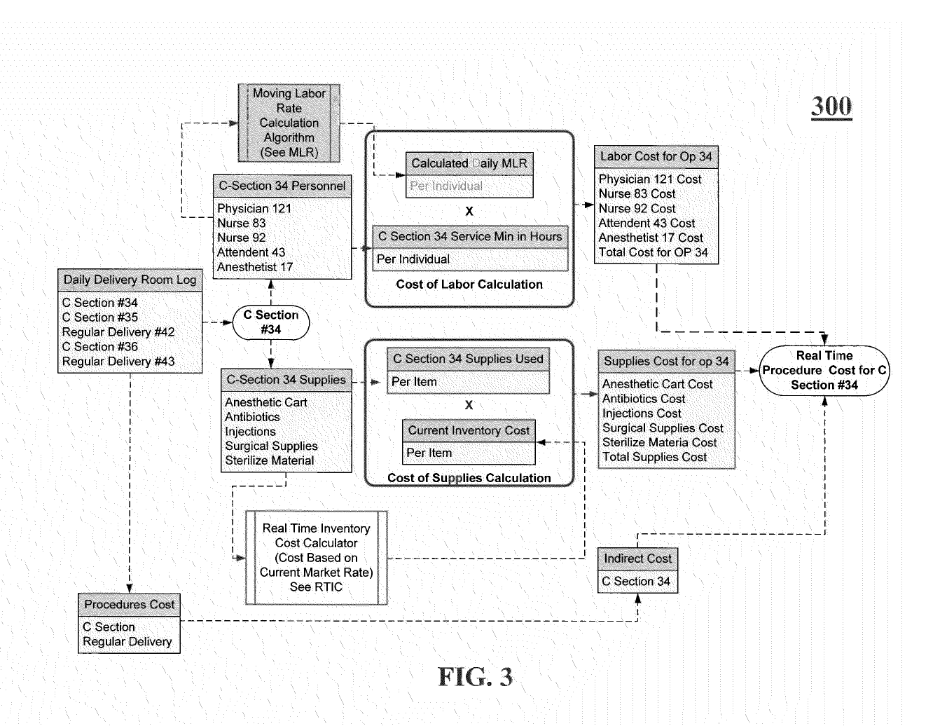

In an embodiment, the real-time MLR for each specific CPT procedure can be calculated by healthcare providers. A real-time procedure rate (RTPR) can include the following factors:
MLR for each type of service provider (e.g., medical, surgical, clinical and administration);
Real-time fringe benefits cost;
Real-time cost of material and supplies;
Unit cost of medical device and/or equipment;
Real-time cost of general and administrative expenses; and,
Overhead—profit margin.
   The aforementioned implies a linkage it has with labor requirements for each procedure. FIG. 3 is an illustration of an example RTPR 300 based on the above factors.

c. Labor Requirements for Health Care Procedures (LRP)

Healthcare service providers are required to bill insurance companies using, for example, authorized ICD-9/ICD-10 clinical codes. In an embodiment, the LRP quantifies the time for each labor category that make up the billing costs of each procedure. Accordingly, to compute real labor cost for each procedure, it is imperative to create an accurate LRP Template for each procedure. Table 2 below is an illustration of an example standardized CPT Cost Template for a regular vaginal birth delivery.

TABLE 2
Example Standardized CPT Cost Template for Vaginal Birth Delivery
Standardized CPT Cost Template: 59400

| | Healthcare | | | Time | | |
|---|---|---|---|---|---|---|
| | Provider Category | Quantity | MLR | (M) | Cost | Total |
| 1) | Labor Cost | | | | | |
| a) | Delivery Reception | 1 | $40 | 15 | $10 | |
| | Unit Clerk | | | | | |
| b) | Physician OB/GYN | 1 | $400 | 45 | $300 | |
| c) | Surgical Assistant | 1 | $200 | 45 | $150 | |
| | res physician) | | | | | |
| d) | Surgical Technician | 1 | $100 | 45 | $75 | |
| e) | Circulating Nurse | 1 | $80 | 60 | $80 | |
| f) | Stocking Nurse | 1 | $80 | 15 | $20 | |
| | (Tech, CRNA) | | | | | |
| g) | Anesthetist | 1 | $240 | 45 | $180 | |
| h) | Nurse for newborn | 1 | $90 | 30 | $45 | |
| i) | Pediatrician for newborn | 1 | $295 | 15 | $255 | |
| j) | House Keeping | 1 | $30 | 30 | $15 | |
| | Personnel | | | | | |
| k) | Maintenance personnel | 1 | $40 | 15 | $10 | $1,140 |
| 2) | Stocking of Supplies | | | | | |
| | and Material | | | | | |
| a) | Anesthesia cart | | | | $62 | |
| b) | Medication | | | | $48 | $110 |
| 3) | Facility Cost | | | | | |
| a) | C Section Room | | | | $200 | |
| b) | Standard Charge | | | | $100 | $300 |
| 4) | Fixed G & A (15%) | | | | | $310 |
| 5) | Other (i.e. profit) | | | | | $0 |
| 6) | Total Cost for Procedure: | | | | | $1,860 |
| | CPT 59400 | | | | | |

A scientific cost template for each type of procedure can be created allowing the hospital to monitor the varying cost of each procedure at the hospital. In an embodiment, both MLR and non-labor costs will change for each specific delivery. Over a week, a month, or a quarter, a hospital can track whether birth delivery costs have increased or decreased in costs; compare costs per physician, nurse or other health care provider; and, make necessary adjustments.

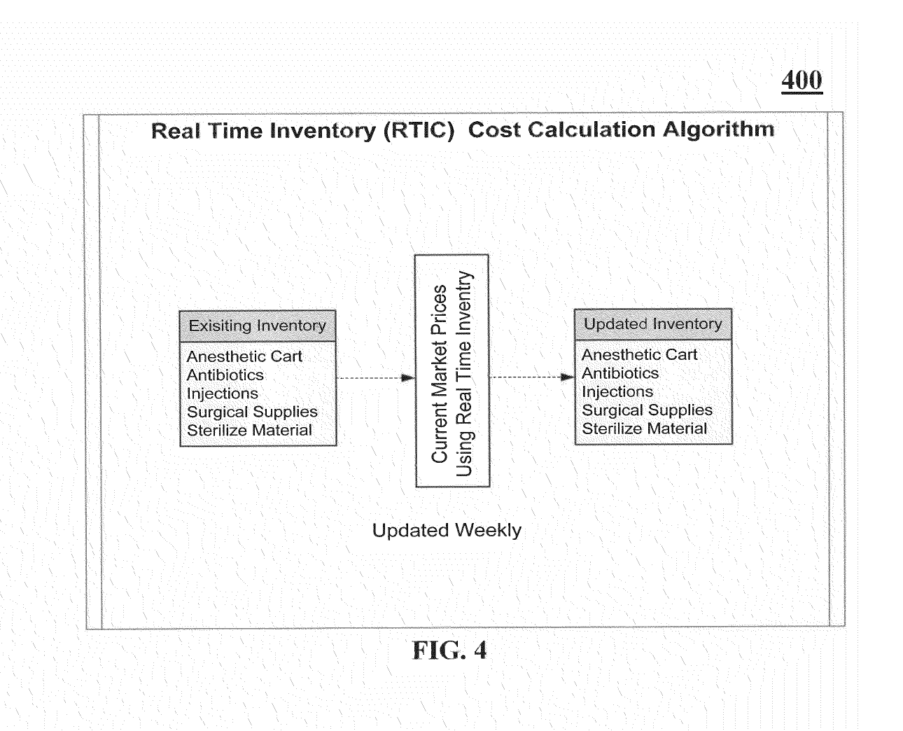

A standardized CPT code calculation template can facilitate cost indices to be developed for all types of CPT codes/procedures, according to an embodiment. FIG. 4 is an illustration of an embodiment of a real-time inventory cost (RTIC) calculation algorithm 400.

### 3. Moving Current Procedural Terminology Code Cost (MCPTCC)

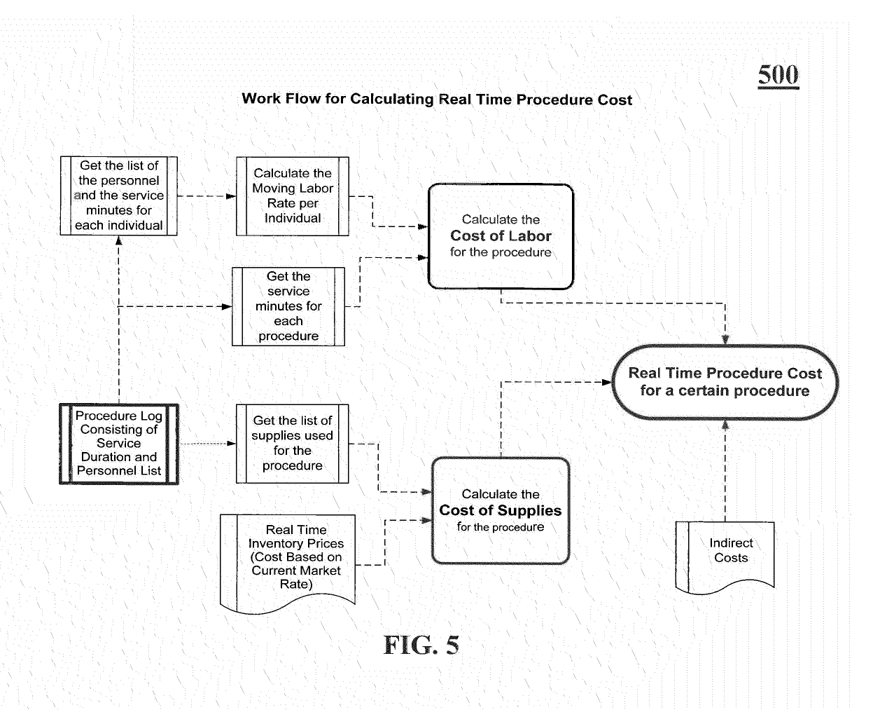

An embodiment uses actual healthcare cost information, clinical, surgical or medical service delivery and patient data to derive a real-time “Moving Labor Rate” that will continually, at every pay period or at other predetermined time interval, adjust the service rate. This Moving Labor Rate (MLR) is based on factors including, for example, actual recorded time incurred by healthcare service providers in providing a specific service. The MLR is then used to compute the true cost of a CPT Code in real-time, according to an embodiment. FIG. 5 is an illustration of an embodiment of a workflow 500 for calculating real-time procedure cost.

Both MLR and MCPTCC are based on reversing the existing process to place up-front a “cost engine” in the hands of the healthcare administrators to derive a healthcare provider's MLR and deliver the MCPTCC, according to an embodiment. Benefits of the embodiments disclosed herein include, among others, enabling healthcare administrators to make system-wide efficiencies, control costs, and achieve savings in a trillion dollar industry. Further, embodiments can help re-organize the cost structure, have built-in accountability, and assure regulatory compliance. Initial calculations associated with the embodiments disclosed herein assists with reforming the cost structure of an imperfect healthcare system that is now dependent on a post-payment rate mechanism.

In an embodiment, RTPR cost indices (RCIs) can be a database index containing the costs of all CPT procedures (real time procedure rate—RTPR). RTPR computes a real time cost for each CPT procedure based on the MLR. RCI data can be calculated for the following spatial levels of healthcare services:
Wards/Units/Departments in a provider institution (i.e. hospital);
Overall hospital;
County (i.e. average of all hospitals in the county);
Regional (i.e. average of all hospitals in the region);
State; and,
National.
   In an embodiment, the above will enable providers/hospitals to review what similar CPI's are getting paid and thereby to implement cost-saving measures without comprising care, for improving its financial health.

The embodiments disclosed herein provide a cost analysis process to compute real-time costs using the current MLR and real-time data feeds of fringe benefits, material and supplies cost (e.g., inventory), general and administrative costs, and fees. This cost analysis process results in a real-time cost for each specific CPT procedure code that is inclusive of all costs—a real time CPT procedure code. Further, this increase in productivity is an efficiency driver that reduces the cost to the hospital, thereby allowing the hospital to transfer the cost savings to the patient/insurance carrier. In an embodiment, the aforementioned calculation for the MLR applies to all medical clinical administrative staff involved in a particular healthcare procedure.

### 4. Additional Embodiments

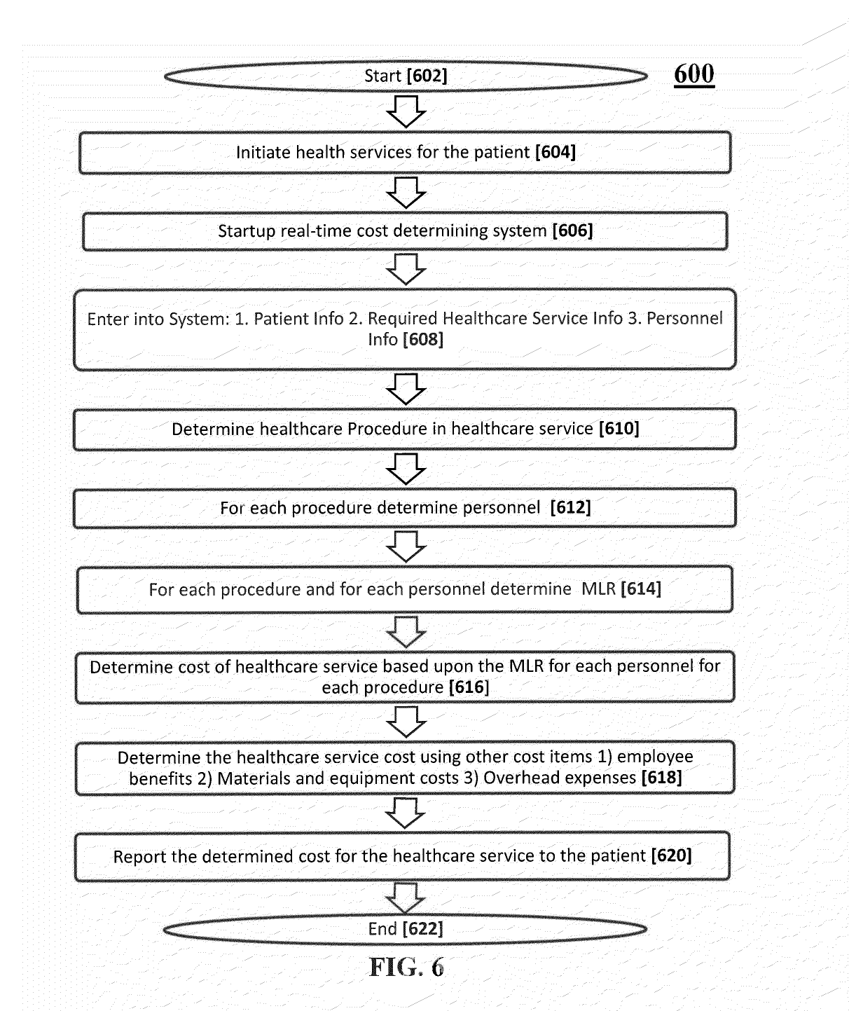

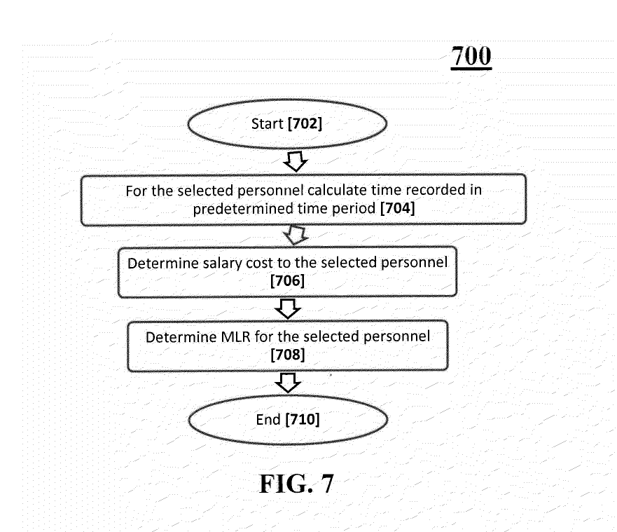

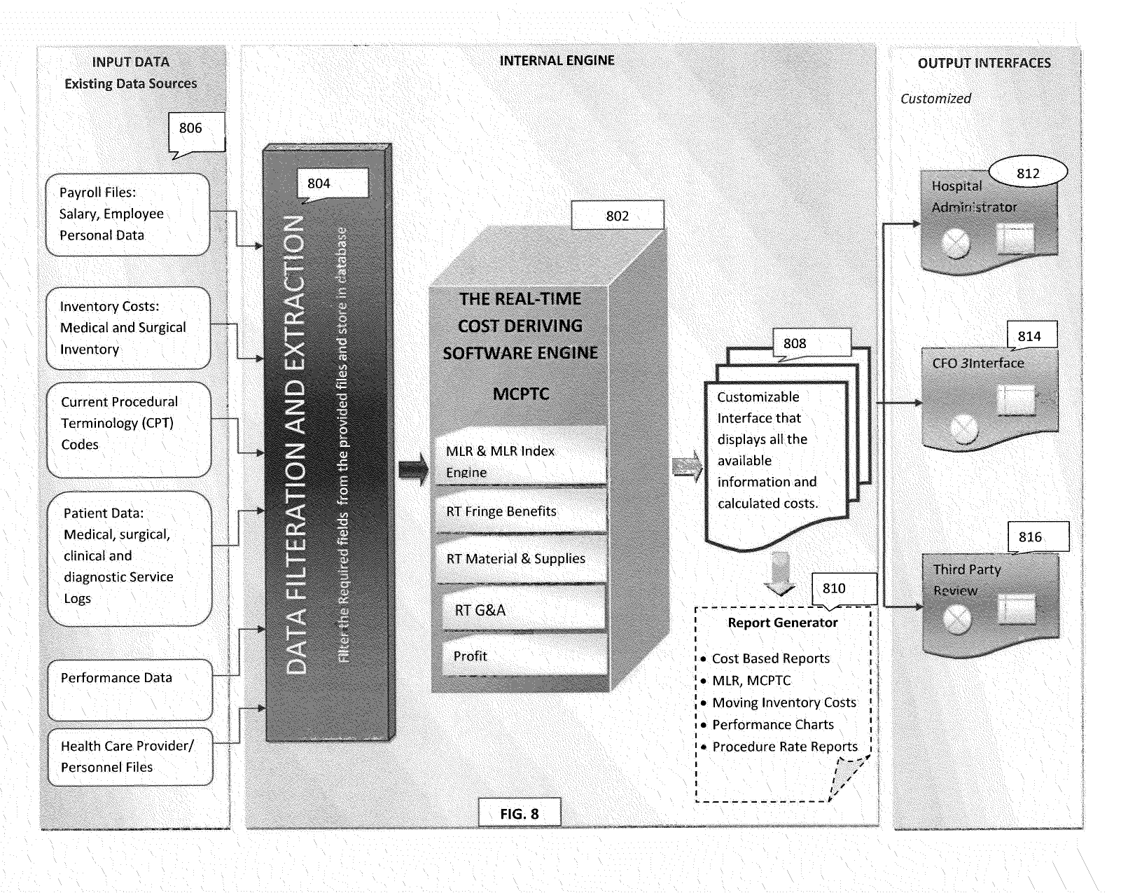

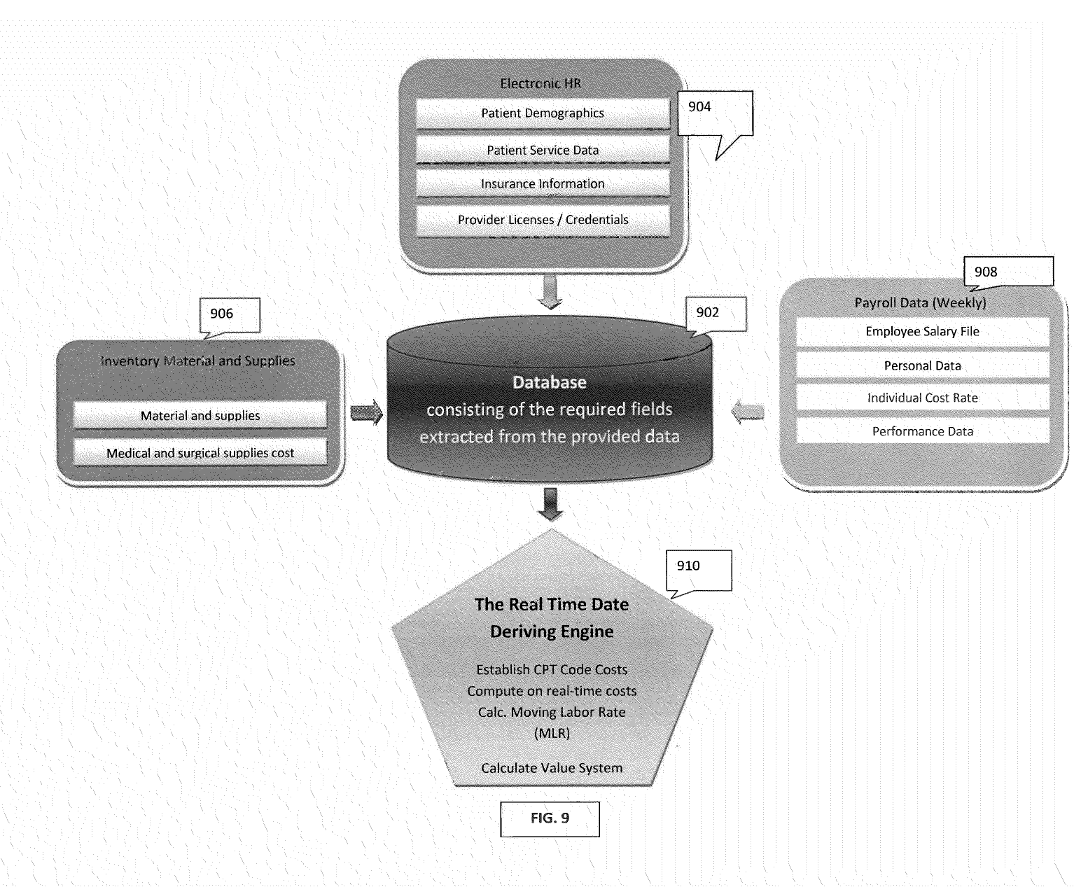

FIGS. 6-9 disclose additional embodiments. FIG. 6 is an illustration of an embodiment of a flowchart 600 depicting the determination of a real-time cost of a healthcare service. FIG. 7 is an illustration of an embodiment of a flowchart 700 depicting the determination of a moving labor rate (MLR) for healthcare service cost determination. FIG. 8 is an illustration of an embodiment of a system for healthcare service cost determination. FIG. 9 is an illustration of an embodiment of database for a real-time healthcare service cost determination system.

The embodiments disclosed herein are described in the context of the healthcare industry for explanation purposes. Based on the description herein, a person of ordinary skill in the art will recognize that the embodiments disclosed herein are applicable to industries. These other industries are within the spirit and scope of the embodiments herein.

### 5. Exemplary Computer System

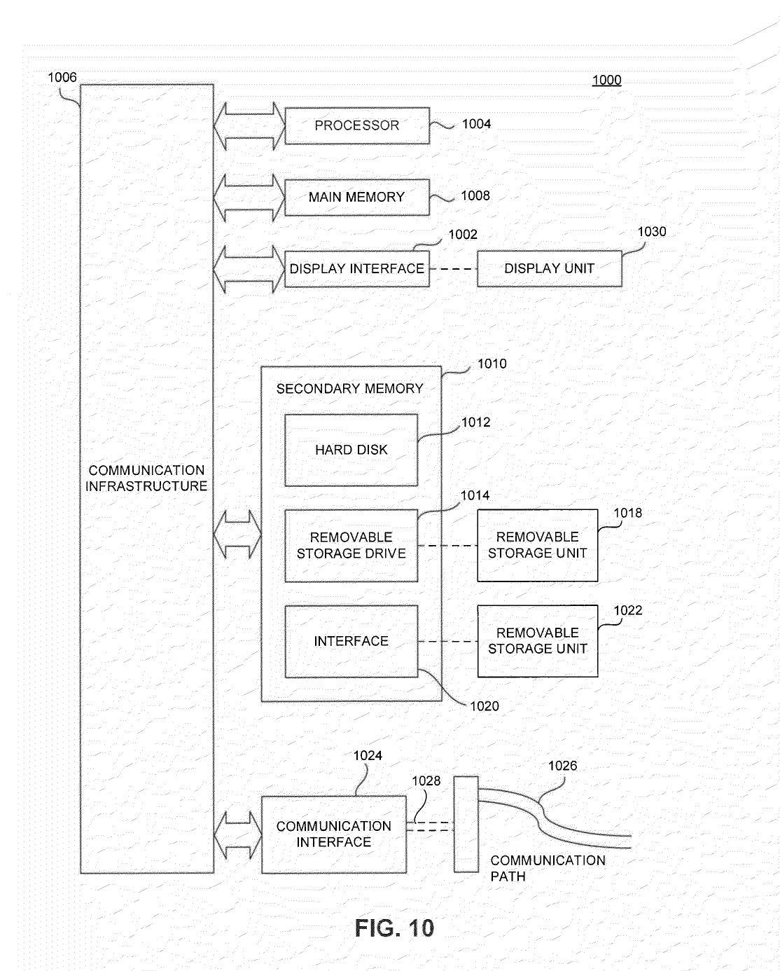

Various aspects of the embodiments disclosed herein may be implemented in software, firmware, hardware, or a combination thereof. FIG. 10 is an illustration of an example computer system 1000 in which embodiments, or portions thereof, can be implemented as computer-readable code. For example, the methods/algorithms illustrated in FIGS. 1-9 can be implemented in system 1000. Various embodiments are described in terms of this example computer system 1000. After reading this description, it will become apparent to a person skilled in the relevant art how to implement the embodiments disclosed herein using other computer systems and/or computer architectures.

It should be noted that the simulation, synthesis and/or manufacture of the various embodiments disclosed herein may be accomplished, in part, through the use of computer readable code, including general programming languages (such as C or C++), hardware description languages (HDL) such as, for example, Verilog HDL, VHDL, Altera HDL (AHDL), or other available programming and/or schematic capture tools (such as circuit capture tools). This computer readable code can be disposed in any known computer-usable medium including a semiconductor, magnetic disk, optical disk (such as CD-ROM, DVD-ROM). As such, the code can be transmitted over communication networks including the Internet. It is understood that the functions accomplished and/or structure provided by the systems and techniques described above can be represented in a core that is embodied in program code and can be transformed to hardware as part of the production of integrated circuits.

Computer system 1000 includes one or more processors, such as processor 1004. Processor 1004 may be a special purpose or a general-purpose processor. Processor 1004 is connected to a communication infrastructure 1000 (e.g., a bus or network).

Computer system 1000 also includes a main memory 1008, preferably random access memory (RAM), and may also include a secondary memory 1010. Secondary memory 1010 can include, for example, a hard disk drive 1012, a removable storage drive 1014, and/or a memory stick. Removable storage drive 1014 can include a floppy disk drive, a magnetic tape drive, an optical disk drive, a flash memory, or the like. The removable storage drive 1014 reads from and/or writes to a removable storage unit 1018 in a well-known manner. Removable storage unit 1018 can comprise a floppy disk, magnetic tape, optical disk, etc, which is read by and written to by removable storage drive 1014. As will be appreciated by a person skilled in the relevant art, removable storage unit 1018 includes a computer-usable storage medium having stored therein computer software and/or data.

Computer system 1000 (optionally) includes a display interface 1002 (which can include input and output devices such as keyboards, mice, etc.) that forwards graphics, text, and other data from communication infrastructure 1006 (or from a frame buffer not shown) for display on display unit 1030.

in alternative implementations, secondary memory 1010 can chide other similar devices for allowing computer programs or other instructions to be loaded into computer system 1000. Such devices can include, for example, a removable storage unit 1022 and an interface 1020. Examples of such devices can include a program cartridge and cartridge interface (such as those found in video game devices), a removable memory chip (e.g., EPROM or PROM) and associated socket, and other removable storage units 1022 and interfaces 1020 which allow software and data to be transferred from the removable storage unit 1022 to computer system 1000.

Computer system 1000 can also include a communications interface 1024. Communications interface 1024 allows software and data to be transferred between computer system 1000 and external devices. Communications interface 1024 can include a modem, a network interface (such as an Ethernet card), a communications port, a PCMCIA slot and card, or the like. Software and data transferred via communications interface 1024 are in the form of signals which may be electronic, electromagnetic, optical, or other signals capable of being received by communications interface 1024. These signals are provided to communications interface 1024 via a communications path 1026. Communications path 1026 carries signals and can be implemented using wire or cable, fiber optics, a phone line, a cellular phone link, a RE link or other communications channels.

In this document, the terms “computer program medium” and “computer-usable medium” are used to generally refer to tangible media such as removable storage unit 1018, removable storage unit 1022, and a hard disk installed in hard disk drive 1012. Computer program medium and computer-usable medium can also refer to tangible memories, such as main memory 1008 and secondary memory 1010, which can be memory semiconductors (e.g., DRAMs, etc.). These computer program products provide software to computer system 1000.

Computer programs (also called computer control logic) are stored in main memory 1008 and/or secondary memory 1010. Computer programs may also be received via communications interface 1024. Such computer programs, when executed, enable computer system 1000 to implement the embodiments disclosed herein. In particular, the computer programs, when executed, enable processor 1004 to implement processes of the embodiments disclosed herein, such as the steps in the methods/algorithms illustrated in FIGS. 1-9 can be implemented in system 1000, discussed above. Accordingly, such computer programs represent controllers of the computer system 1000. Where embodiments are implemented using software, the software can be stored in a computer program product and loaded into computer system 1000 using removable storage drive 1014, interface 1020, hard drive 1012, or communications interface 1024.

Embodiments are also directed to computer program products including software stored on any computer-usable medium. Such software, when executed in one or more data processing device, causes a data processing device(s) to operate as described herein. The embodiments disclosed herein employ any computer-usable or -readable medium, known now or in the future. Examples of computer-usable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

### 6. Conclusion

It is to be appreciated that the Detailed Description section, and not the Summary and Abstract sections, is intended to be used to interpret the claims. The Summary and Abstract sections may set forth one or more but not all exemplary embodiments as contemplated by the inventors, and thus, are not intended to limit the present invention and the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the relevant art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed:

1. A method for determining healthcare service cost, the method comprising:
determining one or more procedures associated with the healthcare service;
determining personnel for each of the one or more procedures;
determining, for each personnel associated with each of the one or more procedures and with a computing device, a personnel cost based on a recorded actual time incurred in a predetermined period; and
determining, with the computing device, the healthcare service cost based on the personnel costs associated with the personal for each of the one or more procedures.

2. The method of claim 1, wherein the predetermined period is dynamically determined based on a current time.

3. The method of claim 1, wherein the recorded actual time is determined based on payroll data from one or more payroll periods.

4. The method of claim 1, wherein the personnel cost is determined based on a total amount earned and total hours worked by the personnel.

5. The method of claim 1, wherein the predetermined period comprise a moving window of a predetermined time period.

6. The method of claim 1, wherein the predetermined period comprises a year-to-date time period or a pay-period-to-date time period.

7. A method for comparing healthcare service cost across a plurality of healthcare providers, the method comprising:
determining, for each healthcare provider and with a computing device, a personnel cost for a healthcare service, wherein the personnel cost is determined based on a recorded actual time incurred in a predetermined period;
comparing, with the computing device, the personnel cost for each of the plurality of healthcare providers; and
selecting, with the computing device, a healthcare provider from the plurality of healthcare providers based on the personnel cost associated with each of the plurality of healthcare providers.

8. The method of claim 7, wherein the healthcare service is associated with a uniform current procedural terminology (CPT) code.

9. The method of claim 7, wherein the determining comprises incorporating a medical supply cost associated with the healthcare service.

10. The method of claim 7, wherein the determining comprises incorporating an overhead cost associated with the healthcare service.

11. The method of claim 7, wherein the determining comprises incorporating an employee benefit cost.

12. The method of claim 7, wherein the healthcare service comprises personnel and healthcare procedures customized to an individual patient.

13. A computer program product comprising a non-transitory machine-usable medium having computer program logic recorded thereon enabling a processor to analyze software code, the computer program logic comprising:
first computer readable program code that enables a processor to receive input data, wherein the input data comprises payroll data, material and supply inventory, and current procedural terminology (CPT) codes;
second computer readable program code that enables a processor to process the input data to determine a real-time cost of a healthcare service; and
third computer readable program code that enables a processor to report healthcare service information based on the real-time cost of the healthcare service.

14. The computer program product of claim 13, wherein the second computer readable program code comprises:
fourth computer readable program code that enables a processor to receive data from at least one of a payroll database system, a human resources database system, an inventory system, or a combination thereof.

15. The computer program product of claim 13, wherein the third computer readable program code comprises:
fourth computer readable program code that enables a processor to provide a customized interface to a healthcare provider administrator, a chief financial officer, or both.
